(19) United States
(12) Patent Application Publication
(10) Pub. No.: US 2023/0294341 A1
(43) Pub. Date: Sep. 21, 2023

(54) MOLDING HAVING A TRANSLUCENT SURFACE LAYER AND METHOD FOR PRODUCING A MOLDING HAVING A TRANSLUCENT SURFACE LAYER

(71) Applicant: DR. SCHNEIDER KUNSTSTOFFWERKE GMBH i. Ins., Kronach (DE)

(72) Inventors: Mario KUEFNER, Kulmbach (DE); Roland WEISSMANN, Kueps-Au (DE); Gustav GEBELEIN, Bad Steben (DE)

(21) Appl. No.: 18/013,519

(22) PCT Filed: Jul. 2, 2021
(86) PCT No.: PCT/EP2021/068405

§ 371 Date: Dec. 28, 2022

(30) Foreign Application Priority Data
Jul. 7, 2020 (DE) 10 2020 117 815.8

(51) Int. Cl. B29C 45/16; B29C 45/14; B60K 35/00; B60R 13/02; B60Q 3/54; B60Q 3/64

(52) U.S. Cl. CPC B29C 45/1671; B29C 45/14221; B29C 45/1615; B60K 35/00; B60R 13/02; B60Q 3/54; B60Q 3/64; B29C 45/14196; B29C 2045/14204; B29C 2045/14532; B29L 2031/3005

(57) ABSTRACT

Disclosed is a molding having a translucent surface layer and to a method for producing a molding that has a translucent surface layer.

A molding with a transilluminable textile, leather, wooden or metallic layer and a method for producing a molding with a transilluminable textile, leather, wooden or metallic layer are described. Such moldings are present in, for example, a vehicle interior and form decorative elements, which can additionally have functional elements and display elements.

### PRIOR ART

Visible surfaces in the interior of motor vehicles such as cars, trucks and buses and also in trains, ships and aircraft are frequently provided with decorative elements so as to create an agreeable and pleasant ambience. For that purpose, for example, use is made of specially treated plastics material simulating an impression of quality surfaces.

There are also facings for surfaces of wood, leather and fabric. However, particularly in the case of the last-mentioned it is often difficult to realise illumination and provide control elements integrated in or below the visible surface. In that regard, there are difficulties not only with area lighting of fabrics, but also with illuminatable symbols.

The methods and moldings known from the prior art in general have the disadvantage that they require many process steps, consist of numerous components or additionally have an increased need for space and a high weight.

EP 3 573 043 A2 discloses a component and a method for producing such a component which comprises a base part with a front side and a rear side, wherein a cover layer made of a lacquer is applied to the front side thereof and forms a part of a visible side of the component. An additional part in contact with the cover layer is completely covered in encircling manner at the edge. The base part has passages extending from the rear side to the front side of the base part, in which case the additional part forms a cover element for sealed covering of the passages, which are completely covered over by the additional part.

DE 100 09 304 A1 discloses a device for producing an injection-molded part, which is provided at one side with a textile and which has a dished three-dimensionally formed surface structure with an edge extending in space, comprising a textile cutting unit for cutting out a textile blank, an actuating device for taking up the textile blank, an injection-molding unit for back-molding the textile blank with plastics material and a processing unit for the finishing of the injection-molded part. In order to reduce textile waste and production throughput times it is proposed that the textile cutting unit comprises cutting means for a contour blank matched to the surface structure and/or edge profile of the finished injection-molded part, that the processing unit is provided with a holding device for twist-free and precise positioning and fixing of the injection-molded part in the desired geometry thereof during the finishing, and that the processing unit comprises a trimming device for fully automatic trimming of the edge profile of the injection-molded part.

### OBJECT

Accordingly, the object consists of indicating a solution for providing moldings with illuminatable or transilluminable textile surfaces, in which rapid, simple and economic production is achieved and an equally simple and economic molding of that kind is provided. Moreover, the object consists of making possible illuminated structures, symbols and/or characters on textile surfaces.

### SUMMARY OF THE INVENTION

The aforesaid object is fulfilled by a molding with a transilluminable surface layer at a visible side, comprising at least
a functional film having at least one transilluminable region,
a surface layer applied to the functional film on the visible side of the molding, wherein the surface layer is formed by a textile, leather, imitation leather, wood veneer or wood laminate or from a metal foil,
a transilluminable layer injection-molded on the rear side of the functional layer and serving as a diffusing pane for incident light, wherein the rear side of the functional layer forms the side opposite the surface layer,

and wherein lateral shielding of the transilluminable layer by bent-over regions of the functional film and the surface layer is realised, wherein a light barrier preventing lateral issue of light is provided by the thus-formed edge fold and wherein an optical conductor into which light can be introduced by way of a light source is arranged at the lower side of the transilluminable layer so that the transilluminable layer formed as a diffusing pane can be illuminated over the whole area by way of the optical conductor for illumination of the at least one illuminatable region.

Through use of the surface layer—which can consist of a textile (for example fabric, woven material or knitted material of natural and/or synthetic materials), leather or imitation leather, wood veneer or wood laminate or of a metal foil (for example aluminium, copper, gold, etc.)—and the functional film as a light barrier the number of components needed for providing the molding is kept to a minimum. In addition, light introduced into the diffusing pane is thereby prevented from lateral escape.

The at least one transilluminable region of the functional film forms the structure, marking and/or pattern visible through the transilluminable layer.

The film is in that case used as a design-imparting element. Illumination is carried out from below in the molding by way of the transilluminable layer formed as a diffusing pane.

The described construction has a very low height and additionally enables representation of symbols, characters and/or patterns on a surface layer.

The aforesaid object is also fulfilled by a molding with a transilluminable surface layer at a visible side, comprising at least
a functional film having a reflective structure and at least one light source, wherein the reflective structure through laterally introduced radiation by the at least one light source produces irradiation at the visible side of the molding,
the at least one light source is integrated in the functional film,
a carrier layer of plastics material injection-molded on the rear side of the functional film, wherein the rear side of the functional film forms the side opposite the visible side of the molding,
an at least regionally transilluminable surface layer disposed on the visible side of the molding, wherein the surface layer is formed by a textile, leather, imitation leather, wood veneer or wood laminate or from a metal foil,
a transilluminable connecting layer arranged between the functional film and the surface layer and connected by a chemical connection and/or a mechanically positive connection with both the functional film and the surface layer,

and wherein
lateral shielding of the transilluminable connecting layer is realised by bent-over regions of the surface layer and
the edge fold realised by the bent-over regions is held by a plastics-material soft component which is injection-molded at the lower side of the functional film at the bent-over regions.

In the case of the molding described here, illumination of the molding takes place by way of a light source such as, for example, light-emitting diodes, which is integrated in the functional film and which is physically connected with the component by being molded around with plastics material. In addition, the functional film has a reflective structure. Such a structure produces, through introduction of light by way of at least one laterally arranged light source, reflection upwardly in the direction of the visible side. In the remaining part of the functional film the light can propagate through the film without radiation in the direction of the visible side. Thus, additional area illumination of the functional film can thereby be achieved, such that depending on the control and configuration of the light source an area (background) illumination through the surface layer is also made possible.

The bent-over regions of the surface layer screen off the sides, particularly the transilluminable connecting layer. The plastics-material soft component is applied as an (encircling) edge to the lower side of the functional film and similarly realises light shielding. In addition, disturbing noise due to vibrations in the vehicle are additionally prevented by use of a plastics-material soft component, because the plastics material soft component serves as a damping element. Moreover, the bent-over regions are held at the underside of the carrier layer by the plastics-material soft component, which is injection-molded from below on the bent-over regions.

As previously mentioned, only a few components are required for the molding, wherein the construction has a very low height and thus the molding can be used for different applications. The use of surface layers of, for example, textile, wood, leather or metallic materials as a decorative layer on the one hand offers a special visual impression and on the other hand reduces the weight of the molding through lower material usage.

As textiles for the textile layers use can be made of, for example, fabrics comprising knitted or woven fabrics. Technical textiles can also be used as textiles for the textile layers. Fibres or filaments of the textiles can be formed by natural or man-made fibres or filaments. By way of example, cotton and synthetically produced fibres may be mentioned in that respect. In addition, illuminatable threads or filaments, for example of glass fibres or plastics material fibres, can be woven in or can find use as (decorative) stitching.

The mentioned moldings are particularly suitable for production in an injection-molding process, in which case moldings can be produced on a large scale and economically and ensure reproducible results with respect to the position and configuration of the structures, patterns and symbols as well as touch and visual aspects of the surface.

Multiple separate production steps for the moldings are therefore not required.

The functional film can comprise at least one functional element for operation and/or control of at least one component, which is connectible by way of a signal connection with the functional film and the at least one functional element. A functional film can comprise, for example, not only illuminatable structures, characters and/or symbols, but also control elements in the form of capacitively, inductively or resistively acting control elements. The functional film is then connected with the controllable components and/or a control unit by way of an interface so that contact with or pressure on the surface in the region of the control zone produces a corresponding reaction. The control zones can be shown by way of the illuminatable regions. In addition, displays for control of the controllable components can be depicted through a surface layer and illustrated by way of states, for example of the controllable components and/or (environmental) parameters.

The aforesaid object is also fulfilled by a method for producing a molding with a transilluminable surface layer at a visible side, in a one-shot process without downstream processes, comprising the following method steps:
providing a functional film and an at least partly transilluminable surface layer, wherein the surface layer is formed by a textile, leather, imitation leather, wood veneer or wood laminate or from a metal foil,
connecting the surface layer with the functional film,
back-molding the functional film with a transilluminable plastics material in an injection-molding process, wherein the transilluminable plastics material is applied to the functional film and at at least one side has an at least regionally smaller dimension than the functional film and
bending over the projecting part consisting of the functional film and surface layer.

The method steps can be performed in an injection-molding process, for which purpose the functional film is inserted into a cavity of a mold half of an injection-molding tool.

In that case, connection of the surface layer with the functional film can take place before or after the back-molding of the functional film. The textile can completely cover the area of the functional film on the visible side so that the light barrier is formed not only by the functional film, but also by the surface layer previously or subsequently laminated thereon.

In the case of all embodiments and methods as well as moldings described herein the surface layers extending completely over the bent-over region have at the sides the same appearance and same touch as at the visible side of the molding, so that in the installed state of the moldings no other layers or components are visible and/or perceptible.

After insertion of the functional film or a composite of the functional film and surface layer the functional film is back-molded by a transilluminable plastics material. The plastics material serves as a diffusing pane for light introduced into the molding from below, so that either an area illumination is achieved or structures, patterns and/or characters are depicted, in which case for that purpose the plastics material is transilluminable only in the region of the characters, symbols and/or structures. With respect to that, methods are known from the prior art for providing a masking. In further forms of embodiment the film can also be appropriately constructed in such a way that this has cut-outs in the region of the structures, characters and/or symbols. In that case, the film itself does not have to be transparent, so that even when a transparent plastics material is used only the appropriate regions are transilluminable.

After back-molding of the functional film, bending-over of the functional film and/or the surface layer can be carried out by way of ejectors, pushers or handling apparatus at the injection-molding machine. In alternative embodiments the injection-molding tool has a further cavity for bending-over of the appropriate regions. Thus, for example, the back-molded component can be sucked on and/or displaced, in which case the regions move against the wall of the tool and are bent over by that.

The aforesaid object is also fulfilled by a method of producing a molding with a transilluminable surface layer at a visible side, in a multi-component injection-molding method in a one-shot process without downstream processes, comprising the following method steps:
inserting a functional film into a cavity of a mold half of an injection-molding tool, wherein the functional film has a reflective structure and at least one light source,
back-molding the functional film in the injection-molding tool with a first plastics material for formation of a carrier layer for the functional film,
transferring the first intermediate product formed from the functional film and the carrier layer into a second cavity of the injection-molding tool,
introducing an at least regionally transilluminable surface layer into the second cavity, wherein the surface layer has a larger area dimension than the first intermediate product and wherein the surface layer is formed by a textile, leather, imitation leather, wood veneer or wood laminate or from a metal foil,
injection-molding a second plastics material between the first intermediate product and the surface layer, wherein the second plastics material connects with the surface layer and the functional film,
bending over projecting regions of the surface layer,
transferring the second intermediate product consisting of functional film, carrier layer, surface layer and second plastics material into a further cavity and
molding around the bent-over regions of the surface layer with a third plastics material at the rear side of the functional film, wherein the rear side is opposite the visible side of the molding.

Production of the molding in an injection-molding process is also carried out by this method, in which case no further processing actions are required. As a result, there are not only large financial savings, but also savings in time. Advantageously, a molding with a very low height in conjunction with a very small weight is provided.

The functional film can image the reflective structure by embossing, by printing or the like.

The connection between the functional film and the surface layer is effected by way of the second plastics material, which, apart from a chemical connection and/or connection by material couple with the functional film and the surface layer, has to ensure radiation therethrough.

The surface layer and the functional film can be inserted into the cavities, clamped in place or sucked down by vacuum.

A transparent or a translucent plastics material can be used for the second plastics material. The visibility of the corresponding characters, symbols or structures produced by the reflective structures can thus be set in dependence on the plastics material used.

The fixing of the edge fold by the third plastics material can be formed from a soft component. The advantages with respect to use of a soft component for the third plastics material have already been mentioned in the foregoing.

Bending-over of the projecting regions of the surface layer can be carried out analogously to the afore-described method in a third cavity or by way of pushers in the injection-molding tool or handling apparatus at the injection-molding machine. The entire production of the molding can thus be realised in an injection-molding tool.

Design elements can also be depicted in a surface layer, so that it is possible to dispense with introduction of structures for that purpose into the functional film. Moreover, it is also possible as an alternative or additional embodiment to perforate the surface layer, in which case openings (more strongly) passing light therethrough are formed in the surface layer by the perforation. Depending on the surface layer, preferably in the case of wood and metal, it is thus also possible to suppress illumination except for the perforated regions.

The solutions described herein enable precise depiction of transilluminated elements on laminated panels and decorative panels or moldings. In addition, production of a transilluminated surface layer in a ‘one-shot’ process without downstream processes is achieved.

Special features are, in particular, the soft/hard lamination in the tool. Integration of electronics and integration of light can also be achieved by the proposed method. For that purpose, the functional film can have corresponding electronic components and/or lighting components or be appropriately constructed for formation of the structures, or optically conductive fibres can be woven into a textile surface layer.

Further advantages, features and possibilities of embodiment are evident from the following figure description of embodiments, which are to be understood as non-limiting.

### BRIEF DESCRIPTION OF THE DRAWINGS

In the drawings:

FIG. 1 shows a schematic illustration of a molding in a first form of embodiment;

FIGS. 2a)-e) shows different states of the molding according to FIG. 1 during production;

FIG. 3 shows a schematic illustration of a molding in a second form of embodiment; and FIGS. 4a)-d) shows different states of the molding according to FIG. 3 during production.

Elements provided in the drawings with the same reference numerals substantially correspond with one another insofar as nothing to the contrary is indicated. In addition, illustration and description of components not essential to understanding the technical teaching disclosed herein are dispensed with. Further, reference numerals are not repeated for all elements already explained and illustrated insofar as the elements themselves and the function thereof have already been described or are known to an expert.

### DETAILED DESCRIPTION OF EMBODIMENTS

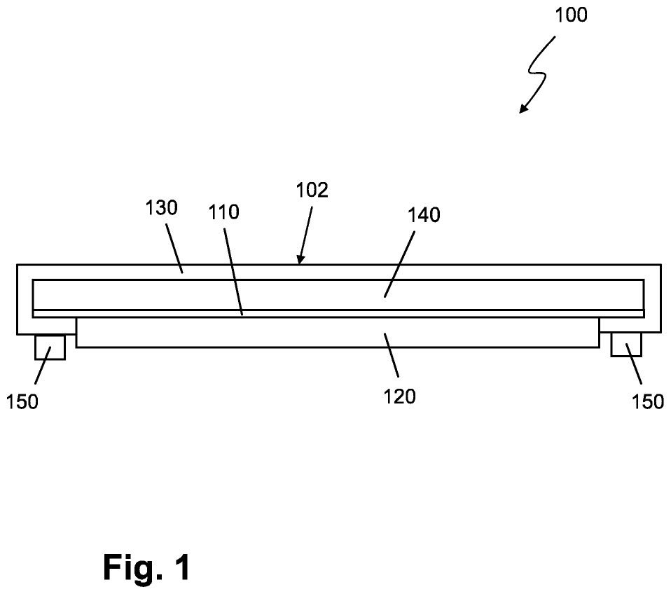

The embodiments, which are shown in FIGS. 1 to 4, of moldings 100 and 200 are constructed as decorative elements for the interior of motor vehicles and each have an in-mold-labeling (IML) functional film 110 or 210 which not only is provided for representation of characters or of symbols or structures by a fabric layer 130 or 230, but also can receive control commands for the control of devices (not illustrated) in the vehicle.

Depending on the construction of the functional film 110 or 210 and the fabric layers 130 or 230, illumination over an entire area and/or illumination only in specific regions for representation of patterns, structures and/or characters or symbols can be achieved.

The embodiments relate to use of fabric layers 130 or 230 as surface layers, but without in that case having a restrictive effect. Other, already known materials are also usable as a surface layer.

### First Embodiment

FIG. 1 shows a schematic illustration of a molding 100 in a first embodiment.

The molding 100 has at its visible side 102 a fabric layer 130 which is connected with a functional film 110 by way of an optically conductive layer 140 consisting of a transparent or translucent plastics material.

The functional film 110 is connected at its rear side with a carrier layer 120 of plastics material. The layer 120 is not transilluminated and can therefore consist of a non-transilluminable plastics material. If the layer 120 is made from a bright (white) plastics material, this can increase the light yield in the direction of the visible side 102 by reflection. By contrast, a dark plastics material for the layer 120 leads to better light shielding in downward direction. The functional film 110 comprises a light source in the form of light-emitting diodes, wherein activation and signal feed as well as power supply take place by way of an electrical connection through the carrier layer 120 or at the side thereof. For that purpose, the carrier layer 120 can have an appropriate opening for reception of connecting lines. In alternative embodiments, the electrical connection is effected at a side region of the carrier layer 120 for contact-making with the corresponding interfaces of the functional film 110.

The functional film 110 has regions which are embossed or so deformed relative to the remaining region of the functional film 110 that a defined light refraction or deflection in the direction of the visible side 102 takes place when light is introduced laterally. The lateral introduction of light is achieved by way of light-emitting diodes integrated in the functional film 110. The reflective structures produced by the deformed regions form indicia, symbols or patterns. Illumination of these by the light-emitting diodes produces on the visible side 102 a corresponding image through the fabric layer 130. For that purpose the fabric layer 130 is transilluminable.

The carrier layer 120 has a smaller area dimension than the functional film 110 and the optically conductive layer 140. By comparison with the functional film 110 and the optically conductive layer 140 the fabric layer 130 has an even larger area dimension and is bent over at the sides, the bent-over sections being held at the lower side of the functional film 110 by way of an encircling edge of a plastics material soft component 150. The soft component 150 preferably consists of a black plastics material so that light shielding is achieved. In addition, the soft component 150 acts as a damper so that no chattering or other disturbing noises in the installed state can arise due to, for example, vibrations in operation of the vehicle. Finally, the soft component 150 serves the purpose of retaining the bent-over regions of the fabric layer 130 against the lower side of the functional layer 110. The soft component 150 can be connected at least regionally with the carrier layer 120 by material couple and/or mechanically positive couple. A ‘hard component’, for example acrylonitrile butadiene styrene plastic, can also be used as an alternative to a soft component.

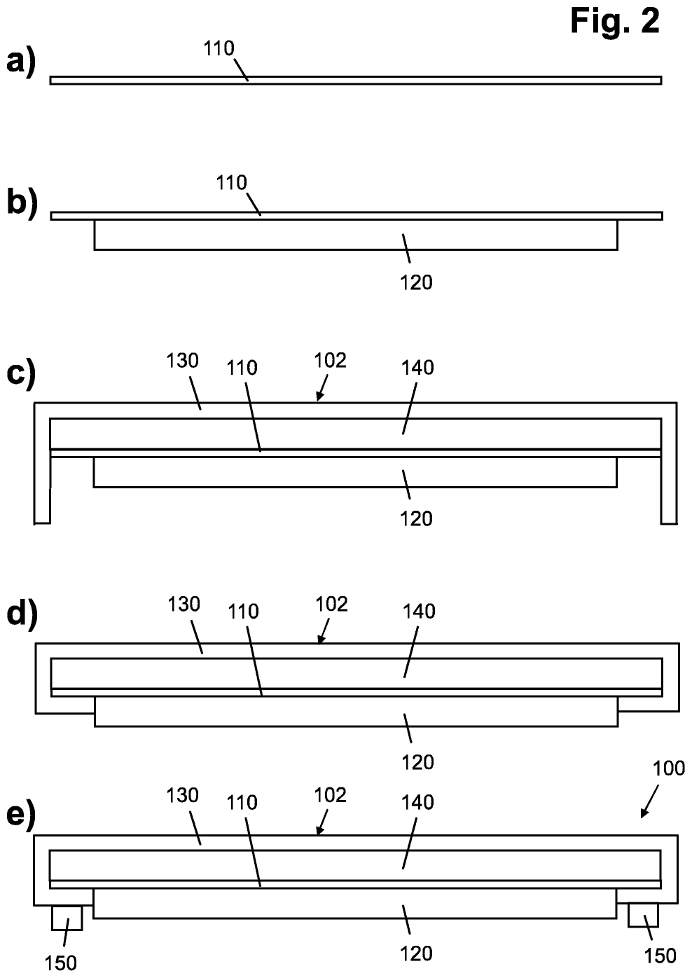

FIG. 2 shows different states of the molding 100 according to FIG. 1 during manufacture. The molding 100 is produced in an injection-molding process with use of an injection-molding tool.

In a first step the functional film 110 is provided and inserted into a first cavity of an injection-molding tool. In addition, the functional film 110 can be sucked down therein so as to adopt a defined position or a two-and-a-half-dimensional to three-dimensional deformation, which is retained during manufacture (FIG. 2a).

In a next step (FIG. 2b) the rear side of the functional film 110, which is opposite the visible side of 102 of the molding 100, is back-molded with a plastics material for formation of the carrier layer 120, which can include mounts or connecting features (clips, detent hooks, screw domes, welding domes, etc.) for later mounting of the molding, these being integrally formed at the carrier layer in the same process step.

Introduction of the fabric layer 130 into a second cavity of the injection molding tool and injection of transparent or translucent plastics material between the functional film 110 and the fabric layer 130, whereby the optically conductive layer 140 is formed, are subsequently carried out. The optically conductive layer 140 enters into a chemical connection and/or mechanically positive connection with the functional film 110 and the fabric layer 130.

Bending-over of the fabric layer 130 until the bent-over regions come into contact with the rear side of the functional layer 110 is thereafter carried out as shown in steps c) and d).

The bending-over of the regions of the fabric layer 130 takes place in a third cavity of the injection-molding tool. Alternatively, this can take place by way of ejectors or pushers in the tool or by means of handling apparatus at the injection-molding machine.

A third plastics material 150 is subsequently injection-molded on the lower side and forms an encircling edge which holds the bent-over regions against the lower side of the functional film 110. The third plastics material 150 can be connected at least regionally with the carrier layer by material couple and/or mechanically positive couple. Designed as a soft component, for example thermoplastic elastomer, the third plastics material 150 additionally serves for reducing disturbing noises such as chattering or creaking.

The finished molding 100 can thereafter be removed from the tool and is ready for installation in a vehicle.

### Second Embodiment

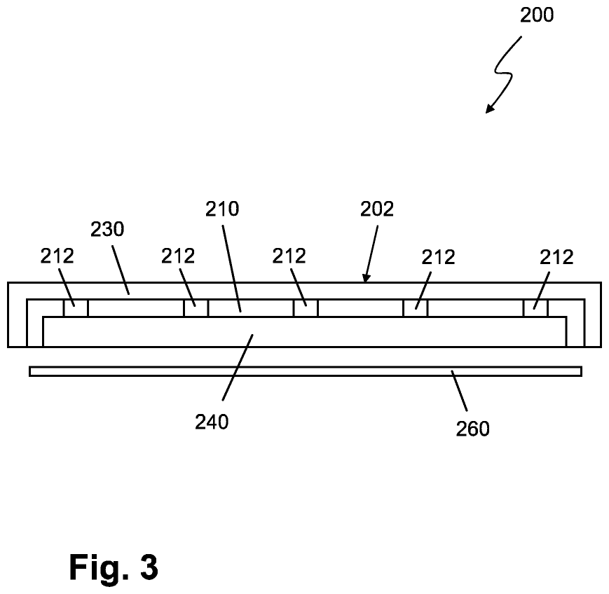

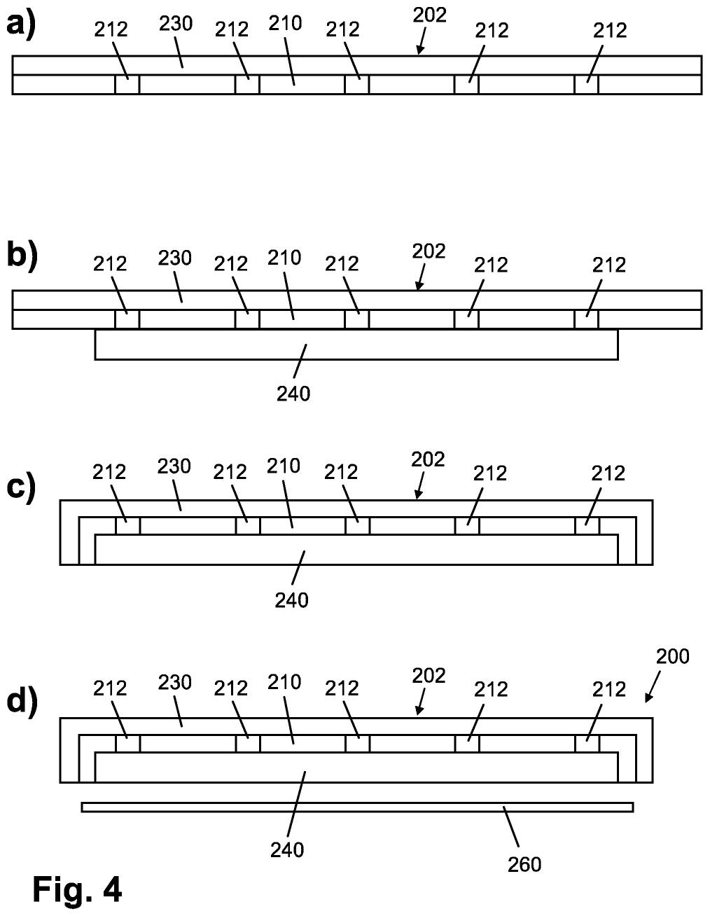

FIG. 3 shows a schematic illustration of a molding 200 in a second embodiment.

The molding 200 differs from the molding 100 in that a diffusing layer 240 of a transparent or translucent plastics material is injection-molded on the rear side of a functional film 210, which is bent over around the diffusing layer 240 like the fabric layer 230.

An optical conductor 260 is arranged on the lower side of the molding 200 and can be connected with the diffusing layer 240 or arranged at a spacing therefrom. In the illustrated embodiments, even if differently depicted, the light conductor 260 is injection-molded on the lower side of the diffusing layer 240. Light can be introduced into the optical conductor 260 by way of a light-emitting diode or other light source, the light thus illuminating the diffusing layer 240 over the entire area and leading to illumination of the regions 212. The regions 212 of the functional film 210 are optically transmissive and thus produce lighting of the fabric layer 130 in the regions 212.

The transparent regions 212 later image the desired transilluminating design through the fabric of the fabric layer 230. The cover layer or fabric layer 230 is, like the fabric layer 130, a fabric or technical textile. The molding 200 can be lit by means of a separate optical conductor 260.

FIG. 4 shows different states of the molding 200 according to FIG. 3 during manufacture.

In the embodiment, connection of the fabric layer 230 with the functional film 210 takes place in a first step (FIG. 4a). The so-called laminating can be carried out in different ways. It is important that the fabric layer 230 enters into a connection with the functional film 210.

Back-molding of the functional film 210 with a translucent or transparent plastics material for formation of the diffusing layer 240 takes place subsequently (FIG. 4b).

In a next step, bending-over of the film 210 and the fabric layer 230 laminated thereon is carried out within the tool, in which case a light barrier for the diffusing layer 240 is achieved.

An optional further process step (not illustrated) follows the process step of FIG. 2e, wherein after the bending-over of the film 210 and of the fabric layer 230 laminated thereon a soft component is injection-molded on the lower side and forms an encircling edge, which fixes the bent-over regions and similarly has damping and/or light-shielding properties.

Finally, the optical conductor 260 is thereafter applied from below to the diffusing layer 240 in a concluding step (FIG. 4d).

### REFERENCE NUMERAL LIST

100 molding
102 visible side
110 functional film
120 carrier layer, first plastics material
130 surface layer, fabric layer
140 optically conductive layer, second plastics material
150 soft component, third plastics material
200 molding
202 visible side
210 functional film
212 region
230 surface layer, fabric layer
240 diffusing layer
260 optical conductor

1: A molding with a transilluminable surface layer at a visible side, comprising
a functional film having at least one transilluminable region,
a surface layer applied to the functional film on the visible side of the molding, wherein the surface layer is formed by a textile, leather, imitation leather, wood veneer or wood laminate or from a metal foil,
a transilluminable layer injection-molded on the rear side of the functional layer and serving as a diffusing pane for incident light, wherein the rear side of the functional layer forms the side opposite the surface layer,
and wherein lateral shielding of the transilluminable layer by bent-over regions of the functional film and the surface layer is realised, wherein a light barrier preventing lateral issue of light is provided by the thus-formed edge fold and wherein an optical conductor into which light can be introduced by way of a light source is arranged at the lower side of the transilluminable layer so that the transilluminable layer formed as a diffusing pane is illuminated over the whole area by way of the optical conductor for illumination of the at least one illuminatable region.

2: A molding with a transilluminable surface layer at a visible side, comprising
a functional film having a reflective structure and at least one light source, wherein the reflective structure through laterally introduced radiation by the at least one light source produces irradiation at the visible side of the molding,
the at least one light source is integrated in the functional film,
a carrier layer of plastics material injection-molded on the rear side of the functional film, wherein the rear side of the functional film forms the side opposite the visible side of the molding,
an at least regionally transilluminable surface layer disposed on the visible side of the molding, wherein the surface layer is formed by a textile, leather, imitation leather, wood veneer or wood laminate or from a metal foil,
a transilluminable connecting layer arranged between the functional film and the surface layer and connected by a chemical connection and/or a mechanically positive connection with both the functional film and the surface layer,
and wherein
lateral shielding of the transilluminable connecting layer is realised by bent-over regions of the surface layer and
the edge fold realised by the bent-over regions is held by a third plastics material which is injection-molded at the lower side of the functional film at the bent-over regions.

3: The molding according to claim 1, wherein the functional film comprises at least one functional element for operating and/or controlling at least one component connectible by way of signal connection with the functional film and the at least one functional element.

4: The method for producing a molding according to claim 1, with a transilluminable surface layer at a visible side, in a one-shot process without subsequent processes, comprising the following method steps:
providing a functional film and an at least partly transilluminable surface layer, wherein the surface layer is formed by a textile, leather, imitation leather, wood veneer or wood laminate or from a metal foil,
connecting the surface layer with the functional film,
back-molding the functional film with a transilluminable plastics material in an injection-molding process, wherein the transilluminable plastics material is applied to the functional film and at least one side has an at least regionally smaller dimension than the functional film and
bending over the projecting part of the functional film.

5: The method according to claim 4, wherein connecting the surface layer with the functional film is carried out prior to or after back-molding the functional film.

6: The method according to claim 4, wherein the surface layer completely covers the area of the functional film on the visible side.

7: The method of producing a molding according to claim 2, with a transilluminable surface layer at a visible side, in a multi-component injection-molding method in a one-shot process without subsequent processes, comprising the following method steps:
inserting a functional film into a cavity of a mold half of an injection-molding tool, wherein the functional film has a reflective structure and at least one light source,
back-molding the functional film in the injection-molding tool with a first plastics material for formation of a carrier layer for the functional film,
transferring the first intermediate product formed from the functional film and the carrier layer into a second cavity of the injection-molding tool,
introducing an at least regionally transilluminable surface layer into the second cavity, wherein the surface layer has a larger area dimension than the first intermediate product consisting of the functional film and carrier layer and wherein the surface layer is formed by a textile, leather, imitation leather, wood veneer or wood laminate or from a metal foil,
injection-molding a second plastics material between the first intermediate product and the surface layer, wherein the second plastics material connects with the surface layer and the functional film,
bending over projecting regions of the surface layer,
transferring the second intermediate product consisting of the functional film, carrier layer, surface layer and second plastics material into a further cavity and
over-molding the bent-over regions of the surface layer with a third plastics material at the rear side of the functional film, wherein the rear side is opposite the visible side of the molding.

8: The method according to claim 7, wherein a transparent or translucent plastics material is used for the second plastics material.

9: The method according to claim 7, wherein the edge fold is fixed by the third plastics material consisting of a soft component.

10: The method according to claim 7, wherein bending-over of the projecting regions of the surface layer is carried out in a third cavity or by way of pushers in the injection-molding tool.

11: The molding according to claim 2, wherein the functional film comprises at least one functional element for operating and/or controlling at least one component connectible by way of signal connection with the functional film and the at least one functional element.

12: The method for producing a molding according to claim 3, with a transilluminable surface layer at a visible side, in a one-shot process without subsequent processes, comprising the following method steps:
providing a functional film and an at least partly transilluminable surface layer, wherein the surface layer is formed by a textile, leather, imitation leather, wood veneer or wood laminate or from a metal foil,
connecting the surface layer with the functional film,
back-molding the functional film with a transilluminable plastics material in an injection-molding process, wherein the transilluminable plastics material is applied to the functional film and at least one side has an at least regionally smaller dimension than the functional film and bending over the projecting part of the functional film.

13: The method according to claim 12, wherein connecting the surface layer with the functional film is carried out prior to or after back-molding the functional film.

14: The method according to claim 5, wherein the surface layer completely covers the area of the functional film on the visible side.

15: The method of producing a molding according to claim 3, with a transilluminable surface layer at a visible side, in a multi-component injection-molding method in a one-shot process without subsequent processes, comprising the following method steps:
inserting a functional film into a cavity of a mold half of an injection-molding tool, wherein the functional film has a reflective structure and at least one light source,
back-molding the functional film in the injection-molding tool with a first plastics material for formation of a carrier layer for the functional film,
transferring the first intermediate product formed from the functional film and the carrier layer into a second cavity of the injection-molding tool,
introducing an at least regionally transilluminable surface layer into the second cavity, wherein the surface layer has a larger area dimension than the first intermediate product consisting of the functional film and carrier layer and wherein the surface layer is formed by a textile, leather, imitation leather, wood veneer or wood laminate or from a metal foil,
injection-molding a second plastics material between the first intermediate product and the surface layer, wherein the second plastics material connects with the surface layer and the functional film,
bending over projecting regions of the surface layer,
transferring the second intermediate product consisting of the functional film, carrier layer, surface layer and second plastics material into a further cavity and
over-molding the bent-over regions of the surface layer with a third plastics material at the rear side of the functional film, wherein the rear side is opposite the visible side of the molding.

16: The method according to claim 15, wherein a transparent or translucent plastics material is used for the second plastics material.

17: The method according to claim 8, wherein the edge fold is fixed by the third plastics material consisting of a soft component.

18: The method according to claim 8, wherein bending-over of the projecting regions of the surface layer is carried out in a third cavity or by way of pushers in the injection-molding tool.

19: The method according to claim 9, wherein bending-over of the projecting regions of the surface layer is carried out in a third cavity or by way of pushers in the injection-molding tool.
